(19) United States
(12) Patent Application Publication
(10) Pub. No.: US 2026/0112337 A1
(43) Pub. Date: Apr. 23, 2026

(54) MUSICAL INSTRUMENT

(71) Applicants: Garrett Bruce Becwar, Cave Creek, AZ (US); Justin Rollefson, Tempe, AZ (US)

(72) Inventors: Garrett Bruce Becwar, Cave Creek, AZ (US); Justin Rollefson, Tempe, AZ (US)

(73) Assignee: RolBec Instruments LLC, Cave Creek, AZ (US)

(21) Appl. No.: 18/922,842

(22) Filed: Oct. 22, 2024

(51) Int. Cl. G10D 7/03; G10D 9/02; G10D 9/10

(52) U.S. Cl. CPC G10D 7/03; G10D 9/02; G10D 9/10

(57) ABSTRACT

A new duct head wind instrument with a compression duct having a multi-section resonating tube containing a plurality of tone holes with a headjoint, neck, upper and lower body and footjoint. The new instrument embodies improvements for wind instruments, duct heads, and compression ducts. These improvements result in increased range, playability, stability, tunability, dynamic range, projection, harmonic stability, responsiveness, tonal characteristics, and ergonomics.

### FIELD OF THE INVENTION

The present invention relates generally to the field of music. More specifically, the present invention is a musical instrument, comprising a head and a resonator, formed of one or more parts/sections that embodies improvements to wind instruments, duct heads, and compression ducts. The musical instrument may be configured to improve range, playability, stability, tunability, decibel level, dynamic range, projection, harmonic stability, responsiveness, tonal characteristics and ergonomics.

### BACKGROUND OF THE INVENTION

Instruments within the classification of ‘wind instruments,’ use wind to produce sound. The exhalation of breath is one source of wind used by wind instruments. A wind instrument typically comprises a head and a resonator.

The head is a portion of the instrument, typically towards the proximal end, where sound originates. The head comprises head components that may be used and/or help in the process of producing sound. A headjoint is a removable head that may contain a portion of the resonator. The resonator is a tube or chamber, distal the head, that contains an air column and determines the pitch and may contain a pitch control mechanism.

The portion of the head that comes into contact with the player is called a mouthpiece. The mouthpiece is where the player exhales their breath. When the breath is exhaled into the instrument, it initiates an airstream. The airstream is utilized by head components to produce pressure waves. The pressure waves set the air column within the resonator into oscillation, producing sound. Wind instruments can initiate sound through a variety of ways. Three of the most common ways include: an airstream flowing across an open-hole in the resonator striking a labium edge (flute instruments), an airstream flowing across a reed (reed instruments), and an airstream flowing through a player's vibrating lips (brass instruments).

The pitch produced by a wind instrument is determined by the length of the resonator. Alterations of pitch are accomplished through the use of a pitch control mechanism, altering the length of the oscillating air column. A common pitch control mechanism for wind instruments are tone holes. Tone holes are openings along the resonator.

There are many different styles of heads for flute wind instruments, the most common being: transverse, duct, and rim-blown. Transverse heads create sound by an airstream flowing across an open hole on the side of the instrument's resonator, being split by the far edge of the hole, causing the air column to oscillate. Examples of a transverse head wind instrument include the concert silver flute, bansuri, dizi, and the nohkan.

Duct heads (commonly referred to as fipple) create sound by an airstream flowing through a duct (commonly referred to as flue) creating an air jet that projects across an open hole (the window) and is split by a labium edge (commonly referred to as splitting edge and cutting edge), causing the air column to oscillate. The airstream increases in velocity when it enters the duct. When the high velocity airstream exits the duct, it creates an air jet. Some of the most common duct head wind instruments are the recorder, Native American flute, Irish penny whistle, and fujara.

Rim-blown heads create sound by directing the airstream from your mouth, across an open end of a resonator, at a labium edge, splitting the airstream, causing the air column to oscillate. Some rim-blown head wind instruments include Anasazi, shakuhachi, xaio, and Turkish and Iranian ney.

The following terms, as used herein, should be defined as follows:

The common dimensional terms described herein will be used throughout to describe the orientation and/or measure of an object. When a part is described, it will be related to its intended position and use on an instrument. The terms will relate to the central axis of an instrument. The “central axis” is the axis extending from the proximal end to the distal end through the center of the instrument. The central axis may follow any contours or bends that may be present along the length of an instrument. The terms used to describe the orientation and/or measure of an object will be length, width, and depth. When viewed from the top, the term “length” will be used to describe the direction extending to the proximal and distal end of the instrument parallel to the central axis. When viewed from the top, the term “width” will be used to describe the direction extending perpendicular to the length. When viewed from the top, the term “depth” will be used to describe the direction perpendicular to both the length and the width, extending into the third dimension. These terms will remain consistent to their original orientation and/or measure when referring to different viewing angles. For example, when viewing a cross-sectional with a lateral orientation parallel to the central axis and a vertical orientation perpendicular to the central axis: the term length will describe the lateral directions and remain the direction parallel to the central axis, the term depth will describe the vertical orientation and remain the direction perpendicular to the length; the term width will describe the direction extending into the third dimension and remain the direction perpendicular to both the length and the depth.

The common dimensional terms described herein will be used throughout to refer to an object's placement. The term “height” refers to the distance the position of an object is related to the central axis.

The term “geometries” comprises: length, width, depth, size, shape, and angle and height.

The “bore” is the measure of the diameter of the resonator excluding any flares or tapers.

There are many limitations with current wind instruments, duct heads, and compression duct designs including instrument capabilities, head component designs and customization.

Current tone hole designs sacrifice the natural resonance and tonal characteristics produced by the full resonator. The fundamental tonality of an instrument is created when the entirety of the resonator is used to produce the pitch. This generally produces the most natural tone of the instrument. Tone holes affect the tonal characteristics as they are punctures along a resonator to simulate a shorter length resonator.

The most accurate way to alter the pitch of an instrument is by using a different length resonator to achieve the desired pitch. As a result of this being completely impractical, the use of tone holes becomes advantageous to add additional pitches to a resonator. The plurality of tone holes creates additional pitches through the consecutive and combination openings of tone holes.

The tone hole size opening results in changes to characteristics of tonal quality, tonal color, projection, decibel level, playable range, response, physical placement, pitch, intonation and cross venting capabilities. The geometries of these tone holes are restricted to the means of what is used to close them. Open-hole instruments use the player's finger pad to close the tone hole, while more modern instruments, such as western flutes and saxophones, use leather pads attached to a lever system, called keys, to seal tone holes. When using keys, the tone holes can be much greater in opening than open-hole instruments. This allows modern instruments to achieve an optimum tone hole opening with a traditional circular tone hole. Open-hole instruments cannot achieve an optimum tone because of physical restrictions of the finger pad closing a large tone hole.

Current open-hole instruments have contact surfaces that are highly unergonomic and make them challenging to seal tone holes. The surface directly around the tone hole, in which the finger pad comes into contact with, is called the “contact surface.” Commonly, the contact surfaces on open-hole instruments are the rounded external surface of the instrument, due to the resonator's external tube shape. The contact surface is lesser in height as its width extends away from the center, creating an uneven surface that is highly un-ergonomic. As a result, this requires the finger pad to be pressed around the convex shape of the contact surface to create a proper seal on the tone hole.

Open-hole instruments do not have any designs to create an ergonomic contact surface to improve playability. Some open-hole instruments configure the contact surface around their double tone holes but not their single tone holes. As a double tone hole would be nearly impossible to seal using one finger, the contact surface is configured to make it functional.

The short-comings of a duct head include limited optimization, projection of sound, decibel level, range, air volume control, dynamics, pitch control, unwanted turbulence and customization.

Current duct head designs have a duct relatively lesser in width due to a greater depth to compensate for inconsistency in manufacturing and materials. The depth of the duct will determine the depth of the air jet being projected across the window at the labium edge. Using a greater duct depth expands the tolerance for the duct to labium height ratio. This may result in imprecision and performance of the instrument.

Current duct head designs with a lesser width duct require a corresponding lesser width labium resulting in less of the air jet being cut by a labium and utilized in the production of sound. The greater depth of the air jet forces the labium to be further away from the windway exit, as it takes a greater distance for the air jet to achieve a proper oscillation before being cut by the labium to produce sound. Consequences of this design consist of limited projection of sound, decibel level, and range.

A duct head design has a limited overall range as a result of their lesser duct width and greater window length. A duct head design typically produces one to three harmonics over the fundamental pitch of the instrument and only one harmonic on other notes in the fundamental octave. As a result, the instrument's overall range is limited to one octave and a minor third for some and up to around two octaves on others.

The greater duct depth requires a lesser duct width to maintain a manageable air volume. The geometries of the duct and windway exit determine the airstream volume needed to produce sound on the instrument. If its geometries are too large, the instrument will be unmanageable to play, as it takes too much airstream volume to make the instrument initiate sound.

The duct head design has an isolated decibel level per register. To increase the decibel level of a wind instrument, the airstream volume must increase. When changing the air volume on a duct head design, there is minimal variability before the pitch will jump or drop to a different harmonic register. This results in an instrument with an isolated decibel level range per register.

The duct head design has a limited dynamic variability per pitch. To alter the dynamics of a wind instrument, the airstream velocity must fluctuate. On a duct head design, fluctuating the airstream velocity will result in the pitch of the tone getting sharper, flatter or ceasing to sound.

Head components are components within the portion of the instrument, referred to as the head, that may be used and/or help in the process of producing sound. Some of the common components consist, but are not limited to: the mouthpiece, slow air chamber, ramp, duct, labium, top wall, bottom wall, upstream cavity and a portion of the resonator.

The duct head has little to no means of customization. There are little to no means of altering or changing any of the head components on an instrument, as they are typically made from one piece of material or multiple pieces permanently adhered together. As a result, this design is configured to the maker's preferences and does not allow for customization to the sound, feel, playability and capabilities for the individual player.

A compression duct is a duct head comprising the addition of at least one of a slow air chamber and a compression chamber. The airstream flows into the slow air chamber, then through to the compression chamber, and then enters the duct.

Compression duct designs still use the similar designs from when they were made from cane with a few modifications. The head was carved from the cane node, forming the table, windway transition, and a top block to enclose the duct.

Current compression duct designs create unwanted turbulence in the windway as they use the same bore measurement as the resonator for the slow air chamber. First, current compression ducts lack fine tuning of the slow air chamber volume to length ratio. A slow air chamber of greater length can reduce turbulence before reaching the compression chamber, but increasing the volume within the slow air chamber too much will hinder the ability of the instrument. Second, this design results in an airstream depth that needs to be drastically compressed into the depth of the duct, causing unwanted turbulence though the compression chamber.

Current compression duct designs continue to utilize the old node wall idea resulting in an elevated duct height. The elevated duct height creates unwanted turbulence within the duct as a result of pushing the airstream from the slow air chamber up into the duct. The elevated duct and corresponding labium edge creates a large labium underface which greatly reduces the capabilities, playability, and range of the instrument.

The diverse range of oral shapes and playing styles make non-customizable mouthpieces a downfall for all instrumentalists. Instrument makers often select mouthpiece geometries that align with their preferences, which may not meet the specific needs or intended use of a player. Additionally, variations in mouthpiece design can significantly impact a player's ability to perform effectively, particularly for individuals with smaller physiques or unique playing styles.

The present disclosure provides a new musical instrument that addresses the shortcomings of previous wind instruments, duct heads, and compression ducts described above. The musical instrument and improvements described herein provide increased range, playability, stability, tunability, decibel level, dynamic range, projection, harmonic stability, responsiveness, tonal characteristics and ergonomics. Other benefits and advantages will become clear from the disclosure provided herein and those advantages provided are for illustration. The statements in this section merely provide the background related to the present disclosure and do not constitute prior art.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one or more embodiments of the present invention, a musical instrument is disclosed. A musical instrument comprising: a head and a resonator wherein the resonator is positioned distal the head and at least one of the head and the resonator allows one to change at least one of the range, the response, the feel, the ergonomics, and the tonal characteristics.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The FIGURES are not necessarily drawn to scale and certain FIGURES may be shown in exaggerated or generalized form in the interest of clarity and conciseness. The disclosure itself, however, as well as a mode of use, further objectives and advantages thereof, will be best understood by reference to the following detailed description of illustrative embodiments when read in conjunction with the accompanying drawings, wherein:

FIG. 1 is a side cross-sectional view of a portion of a duct head with a compression duct, where grouping of head components of the head are identified;

FIG. 2 is a side cross-sectional view of the portion of the duct head with a compression duct of FIG. 1, where singular head components of the head are identified; and

FIG. 3 is a side cross-sectional view of the portion of the duct head with a compression duct of FIG. 1, where the resonator parts are identified;

FIG. 4 is a side cross-sectional view of a headjoint section of an embodiment of the present invention;

FIG. 5 is a perspective view of a head component system of the musical instrument of the present invention;

FIG. 6 is an exploded perspective view of the head component system of FIG. 5;

FIG. 7 is an exploded perspective view of the musical instrument of the present invention;

FIG. 8 is top view of elongated tone holes shown on the upper body section of the present invention;

FIG. 9 is a bottom view of a squircle tone hole on the lower body section of the present invention; and

FIG. 10 is a perspective view of the finger-plates on the upper body section of the present invention.

### DESCRIPTION OF THE APPLICATION

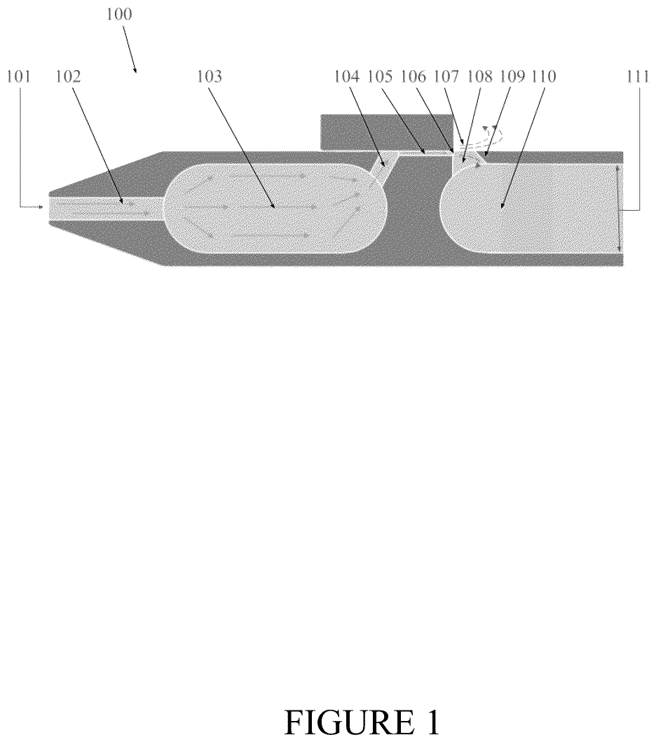

Referring to FIGS. 1-3, a duct head with a compression duct is shown. FIG. 1 shows the head 100 of the duct head with a compression duct and identifies grouping of components. The windway entrance 101 is the proximal most portion of the instrument and is where the player expels their breath, initiating the airstream into the windway 102. The windway 102 (indicated by arrows) refers to the space inside the head 100 between the windway entrance 101 and the windway exit 106 that directs the airstream. The slow air chamber 103 is the area of the windway 102 that begins after the mouthpiece 201 and ends at the compression chamber 104. The slow air chamber 103 is the portion of the windway 102 with a high-volume, slow-moving airstream. The compression chamber 104 is the portion of the windway 102 that begins at the termination of the slow air chamber 103 and ends at the initiation of the duct 105. The compression chamber 104 is the transitional area between these two portions. The geometries of the compression chamber 104 will determine the rate of compression of the airstream volume from the slow air chamber 103 to the duct 105. The duct 105 is a portion of the windway 102, with a low-volume, fast-moving airstream, contained between the distal end of the compression chamber 104 and the windway exit 106. The windway exit 106 is found at the termination of the duct 105 where the airstream exits the windway 102. The air jet 107 (indicated by dashed arrows) is the airstream that is projected from the duct 105 out the windway exit 106. It takes the shape of the duct 105 and projects across the window 108 before striking the labium 109. This air jet 107 results in the oscillation of pressure in and out of the resonator 110 as the air jet 107 is divided by the labium 109 resulting in the pitch produced by the instrument. The window 108 is the opening initiating at the windway exit 106 and terminating at the initiation of the labium 109 between the labium walls 213. This area is the opening towards the proximal end of the resonator 110, making the instrument an open-ended tube. The resonator 110 on a duct head begins at the bottom wall 211.

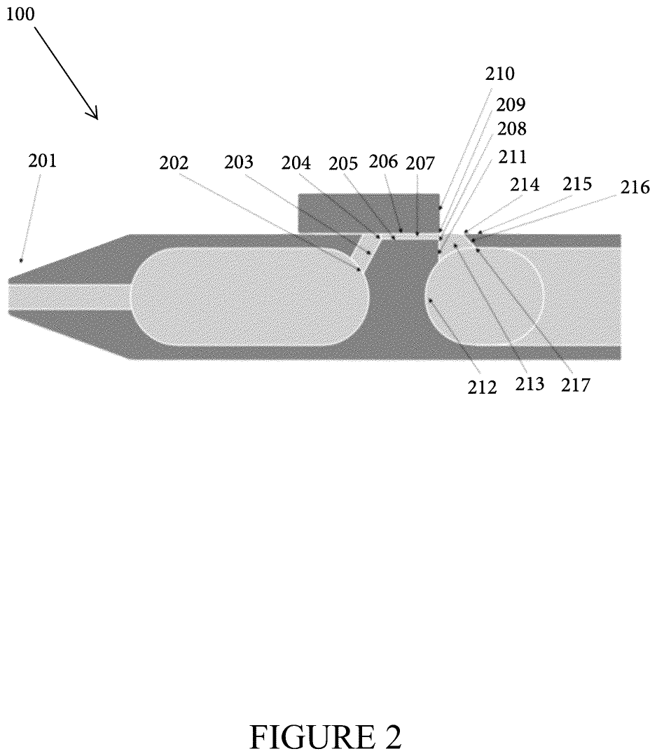

FIG. 2 shows the components of the head 100. The mouthpiece 201 is the proximal end of the head 100 that is the direct receptacle for contact with the player. The compression chamber 104 contains the slow air chamber-ramp transition 202 ramp 203, and ramp-table transition 204. The slow air chamber-ramp transition 202 is the transition area between the slow air chamber 103 and the ramp 203. The ramp 203 is the lower boundary of the compression chamber 104. The ramp-table transition 204 is the transition area between the ramp 203 and the table 205. The duct 105 contains the table 205, duct walls 207, and ceiling 206. The table 205 is the surface creating the lower boundary of the duct 105, beginning at the termination of the compression chamber 104 and extending to the windway exit 106. The ceiling 206 is the surface creating the upper boundary of the duct 105, beginning at the termination of the compression chamber 104 and extending to the windway exit 106. The duct walls 207 are the surface on each side of the duct 105 extending between the table 205 and the ceiling 206. These surfaces create the side boundaries of the duct 105. The table bevel 208 and ceiling bevel 209 are the sloped edges of the table 205 and ceiling 206 at the windway exit 106. These bevels 208, 209 result in the expansion of the windway exit 106 directing the air jet 107 as it exits the windway 102. The top wall 210 is the surface located directly above the windway exit 106. The top wall 210 begins at the termination of the duct 105, and extends to the external surface of the head 100. The bottom wall 211 is the surface located directly below the windway exit 106. The bottom wall 211 begins at the termination of the duct 105, and extends into the internal surface of the head 100. The upstream cavity 212 is a cavity created after a manipulation to the bottom wall 211 that extends towards the proximal end of the head 100, resulting in an expansion to the resonator 110. The labium walls 213 are the surfaces on the edges of the window 108 beginning at the termination of the duct 105 and ending at the termination of the labium 109 and extend from the resonator 110 to the external surface of the head 100. The labium walls 213 may have a sloped or angled orientation connecting the internal surface of the resonator 110 and the external surface of the head 100. The labium 109 refers to a grouping of components which comprise: the labium walls 213, labium edge 214, labium face 215, labium underface 216, and the labium underface-resonator transition 217. The labium edge 214 is the proximal most portion of the labium 109. The labium edge 214 is the resulting edge or surface formed by the meeting of the labium face 215 and labium underface 216 surfaces. The labium face 215 is the surface that extends from the labium edge 214 to the external surface of the head 100 from the proximal end towards the distal end of the head 100. The labium underface 216 is the surface that extends from the labium edge 214 to the labium underface-resonator transition 217. The labium underface-resonator transition 217 is the transition from the distal end of the labium underface 216 to the resonator 110.

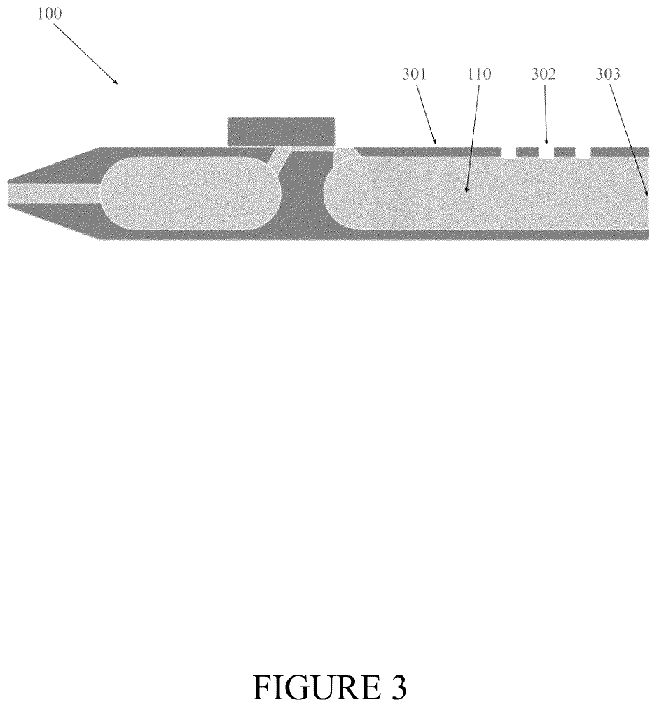

FIG. 3 shows the parts of the resonator 110 of the duct head instrument 10. The resonator 110 is the internal cavity of the instrument which begins at the bottom wall 211 and extends to the resonator-termination 303. The body 301 of an instrument is the portion of the resonator 110 that starts at the termination of the head 100 and ends at the resonator-termination 303. The body 301 may consist of a plurality of tone holes 302. Tone holes 302 are openings formed in the resonator 110 of an instrument.

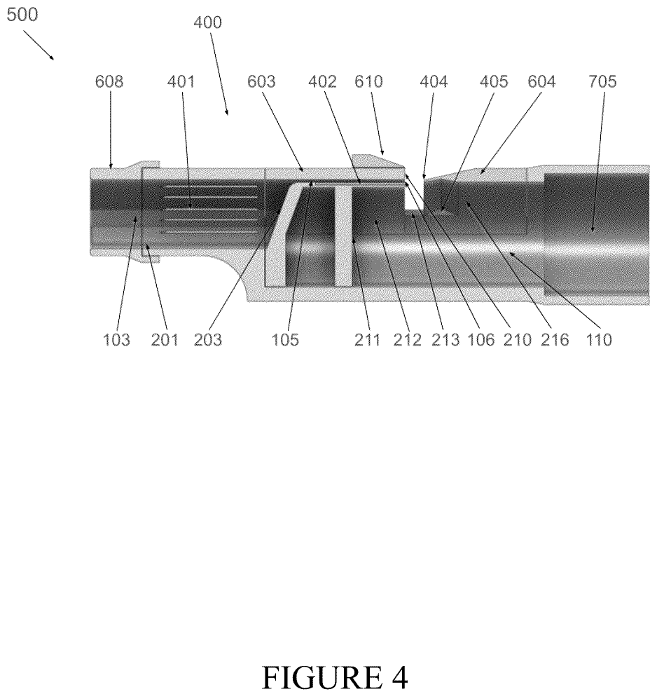

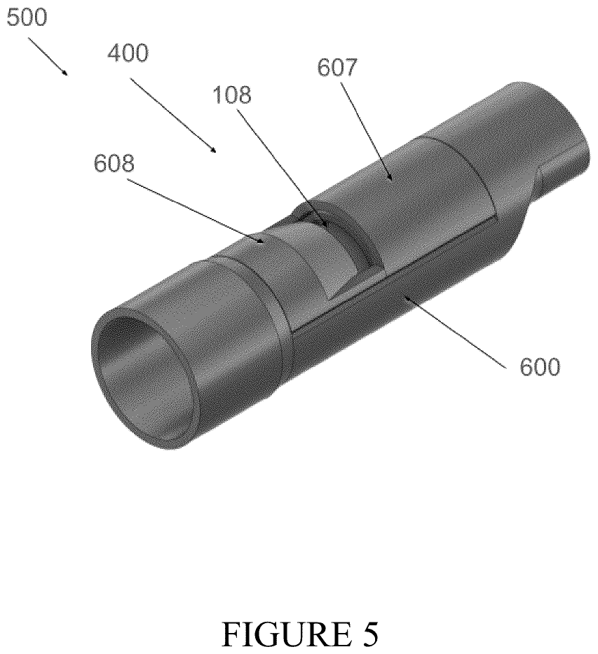

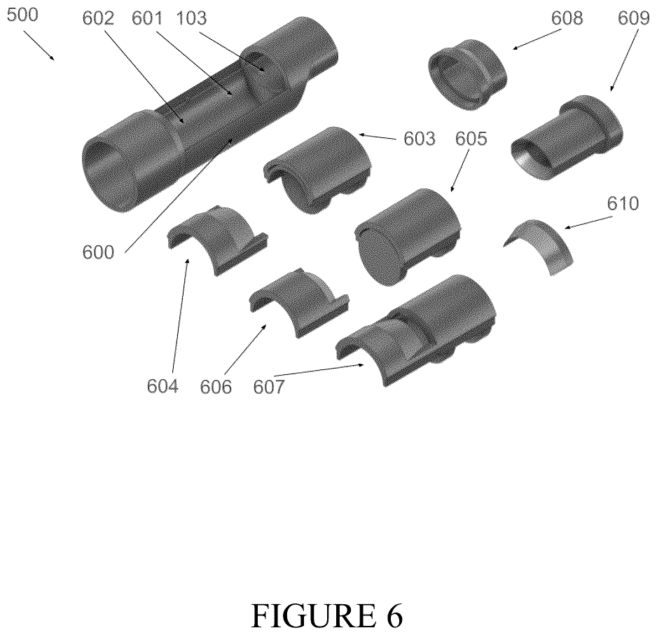

Referring to FIGS. 4-10, the musical instrument 10 of the present invention is shown. FIG. 4 shows a side cross-sectional view of the head 100 of the musical instrument 10, referred to as a headjoint 400 of the present invention. The mouthpiece 201 is shown having a unique elongated width shape. Preferably, the mouthpiece 201 when viewed from the proximal end, perpendicular to the central axis, will have the same cross-sectional geometries as the slow air chamber 103. The windway structures 401 are the addition of objects or dividers within the windway 102 that form, alter or guide the airstream. Duct channeling 402 are depressions, channels, or nicks formed into the duct 105, altering the shape and the flow of the air jet 107. The beard 610 is part of or an attachment above the top wall 210, that alters the flow of entrained air into the air jet 107 by configuring its geometries to and around the top wall 210. The micro-shaped labium edge 404 is the configuration of the surface created between the labium face 215 and the labium underface 216. The airfoil cavity 405 is a space or cavity on the labium underface 216 or internal surface of the resonator 110 following the labium edge 214.

Referring to FIGS. 4-7, the musical instrument 10 of the present invention may use a head component system 500. The head component system 500 describes a headjoint 400 with one or more removable and insertable head components,, which may allow for manipulation of the range, playability, stability, tunability, dynamic range, projection, harmonic stability, responsiveness, tonal characteristics and ergonomics of the musical instrument 10. It should be noted that the head component system 500 may be extended and used on any type of duct head instruments.

The head component system 500 may be formed of a plurality of different combinations. In the present embodiment, the system 500 may have: a headjoint shell 600, a mouthpiece cap 608, a slow air chamber insert 609, a windway insert 603, and/or a labium insert 604. The headjoint shell 600 is the headjoint 400 of the instrument 10 and contains the mouthpiece 201, slow air chamber 103, windway socket 601, and labium socket 602, and the socket 705. The windway socket 601 is the receptacle area within the headjoint shell 600 which receives and houses the windway insert 603. The labium socket 602 is the receptacle area within the headjoint shell 600 which receives and houses the labium insert 604. The mouthpiece cap 608 is a device that is inserted inside or around the end of the mouthpiece 201.

The mouthpiece cap 608 may allow one to change the geometries of the slow air chamber 103. This may allow one to configure the mouthpiece 201 The slow air chamber insert 609 is a device that may allow one to change the geometries of the slow air chamber 103 and may add windway structures 401 to the slow air chamber 103. The windway insert 603 may contain the slow air chamber 103, slow air chamber-ramp transition 202, ramp 203, ramp-table transition 204, and duct 105. The labium insert 604 may contain the parts of the labium 215 and may create a portion the window 108.

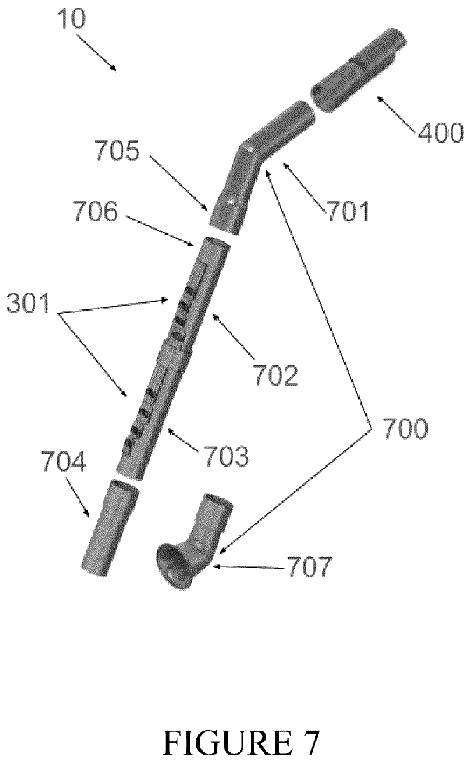

FIG. 7 is an exploded perspective view musical instrument 10 of the present invention. FIG. 7 shows a multi-section resonator 110 of musical instrument 10. A multi-section resonator 110 is a musical instrument with a resonator 110 that is made up of two or more sections. The musical instrument 10 with a multi-section resonator 110 can include: a headjoint 400, a neck 701, an upper body 702, a lower body 703, a footjoint 704, one or more sockets 705, and one or more tenons 706. FIG. 7 depicts an alternate footjoint 704, for instrument 10, comprising a bell 707 with a bend 700.

The sections of the multi-section resonator 110 may be connected using a system comprising a socket 705 and a tenon 706. The socket 705 is a cavity with geometries to receive and house a portion of the tenon 706 of a resonator 110, and may create a friction fit connection. The tenon 706 has the geometries to be inserted into and housed within the socket 705, and may create a friction fit connection.

The headjoint 400 is the proximal most section of the instrument 10. It is connected to the neck 701 by the means of a socket 705 and tenon 706. The neck 701 is a section of the resonator 110 which at the proximal end connects to the headjoint 400 and at the distal end connects to the upper body 702, both of which may attach by the means of a socket 705 or tenon 706. The body 301 is typically the largest section of the resonator 110 and hosts a plurality of tone holes 302. The body 301, at the proximal end, connects to the neck 701 and at the distal end connects to footjoint 704, both of which may attach by the means of a socket 705 or tenon 706. The upper body 702 is a section of the body 301 which may contain a plurality of tone holes 302 for one of the player's hands. The proximal end connects to the neck 701 and the distal end connects to the lower body 703, both of which may attach by the means of a socket 705 or tenon 706. The lower body 703 is a section of the body 301 which may contain a plurality of tone holes 302 for one of the player's hands. The proximal end connects the lower body 703 to the upper body 702 and the distal end connects to the footjoint 704, both of which may be coupled by the means of a socket 705 or tenon 706. The footjoint 704 is the final section of the resonator 110 containing the distal end of the resonator 110. The proximal end of the footjoint 704 may connect to the lower body 703 by the means of a socket 705 or tenon 706. The footjoint 704 may contain a flare in bore 111 diameter called a bell 707 towards the distal end of the resonator 110 of musical instrument 10.

The bends 700 of the musical instrument 10 may allow for ergonomic, functional and capability improvements over the traditional duct head instruments.

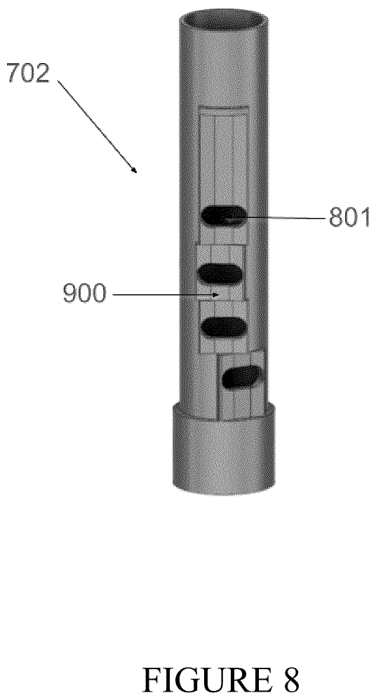

FIG. 8 is the front view of an elongated tone hole 801 shown on the upper body 702 section of the musical instrument 10.

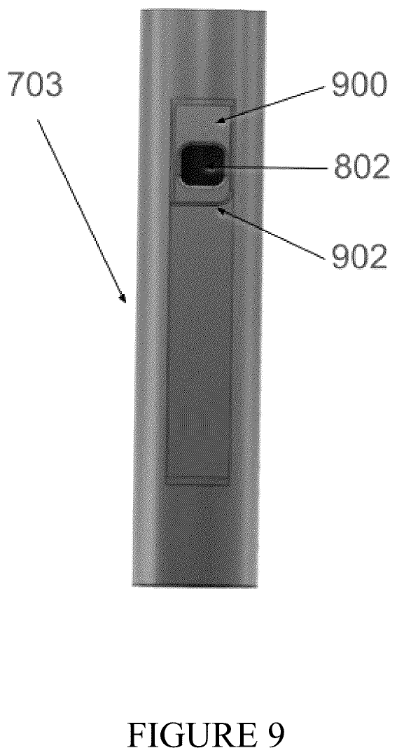

FIG. 9 is a rear view of a squircle tone hole 802 on the upper body 702 section of the musical instrument 10.

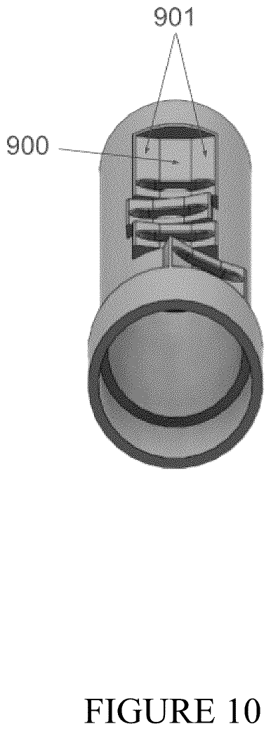

FIG. 10 is a perspective view of width contouring 901 of the finger-plates 900 on the upper body 702 section of the musical instrument 10.

The musical instrument 10 of the present invention presents solutions to the above-mentioned shortcomings of wind instruments. The solutions of the present inventions will be discussed in further detail.

### Elongated Tone Hole

The elongated tone hole 801 design of musical instrument 10 may provide many improvements over circular tone holes 302 such as: response, playability, playable range, harmonic stability, half-holing, microtonal capability, tonal quality, tonal color, projection, decibel level, intonation, and ergonomics. The elongated tone hole 801 design is a tone hole 302 in which the opening has a width measure greater than the length measure. The elongated tone holes 801 may have one or more sets of parallel edges and these edges may be straight or curved and connected by angles or curves. Examples of an elongated tone hole 801 shape may consist, but are not limited to: a pill, an ellipse, a rectangle, and an oval.

Generally speaking, the best way to alter the pitch of an instrument is to change the length of its resonator 110. Using the full length of an instrument's resonator 110 produces the most natural and resonant tone. Tone holes 302 are typically used to create additional pitches from the resonator 110 through venting, resulting in a less natural and less resonant tone. Elongated tone holes 801 better replicate the tonal characteristics of a full length resonator 110 across the entirety of the instrument's range.

The elongated tone holes 801 are more efficient in the venting of the air column than circular tone holes 302. This is proven through tests of having a circular tone hole 302 in the exact location of an elongated tone hole 801, both having the same surface area opening to the resonator 110. The result of this test reveals the elongated tone hole 801 has a lower sounding pitch than the circular tone hole 302. This shows that the air column is being vented more effectively with the elongated tone hole 801 over a circular tone hole 302.

Additionally, the more efficient elongated tone hole 801 improves the overall range of a musical instrument. Furthermore, harmonic stability is improved and overtones are more stabilized and isolated.

The elongated tone hole 801 design allows for a greater tone hole size opening occupying less length along the resonator 110. As a result, this allows for larger tone holes 302 to be positioned closer together. This is beneficial when designing any instrument with tone holes 302. Finally, the elongated tone hole 801 increases the amount of internal surface of the resonator 110 that is not being removed for large circular tone holes 302, causing less turbulence within the resonator 110.

Half-holing is a technique in which a player will cover a portion of the tone hole 302 to produce a pitch in between two consecutive tone holes 302. In a circular tone hole 302 design, the ability to accurately half-hole is difficult. The elongated tone hole 801 is much easier to half-hole, giving the player more control over how much of the tone hole 302 is being covered. Genres and techniques that greatly benefit from this ability are microtonal music, pitch bends and glissandos.

Finally, the elongated tone hole 801 has better ergonomic benefits than a circular tone hole 302 on open-hole instruments. The elongated shape mimics the shape of the player's entire finger pad, allowing for greater tone hole 302 size openings with a more natural feel.

### Squircle Tone Holes

The squircle tone hole 802 design of musical instrument 10 provides improvements over circular tone holes 302. When a squircle tone hole 802 is used for some or all of the tone holes 302 on an instrument, improvements are shown in: response, playability, playable range, harmonic stability, and ergonomics. A squircle shape is an intermediate between a square and a circle, or a combination of at least two of a square, a circle, a rounded corner, and a curved edge.

Like the elongated tone holes 801, a squircle tone hole 802 is more efficient in the venting of the air column than circular tone holes 302. The squircle tone hole 802 allows a greater tone hole 302 size opening compared to a circular tone hole 302 in the same area.

The squircle tone hole 802 on an open-hole instrument provides the greatest benefit for the player's thumb. The shape of the thumb pad and the vertical orientation of the thumb, when playing an instrument, lends itself to the benefits of the squircle tone hole 802 as it provides the greatest tone hole 302 size opening ergonomic benefit.

### Width Contouring of Finger-plates

Width contouring 901 of the finger-plates 900 present a drastic improvement over traditional open-hole instruments in the areas of ergonomics and playability with improved speed, accuracy and repetition of finger movement. Width contouring 901 of the finger-plates 900 refers to configurations to the finger-plate 900 wherein the surface of the finger-plate 900 extends upward from flat as the width extends from the center. As a result, width contouring 901 improves the ergonomics and better replicates the fingers geometries. For example, the finger-plate 900 may consist of a flat central portion transitioning to a width contouring 901 portion wherein a surface of the finger-plate 900 extends upward as a width extends from the center. The width contouring 901 can have a greater or lesser angle depending on the finger it is complimenting. Additionally, the finger-plate 900 can be configured as it extends along its length. Finally the geometries of the width contouring 901 can be configured to better compliment the natural geometries of the finger pad.

### Thumb-plate Contouring

The musical instrument 10 of the present invention configures the contact surface of the tone hole 302 utilized by the thumb on open-holed instruments. Thumb-plate contouring 902 presents an improvement over open-hole instruments in the areas of ergonomics and playability with improved speed, accuracy and repetition of finger movement.

Thumb-plate contouring 902 refers to the configuration of the finger-plates 900 for the thumb consisting of a lowered surface distal the thumb tone hole 302. This configuration aids in a rocking motion of the thumb while sealing and opening a tone hole 302. As a result, thumb-plate contouring 902 improves the ergonomics and better replicates fingers'natural motion and geometries. For example, the thumb-plate contouring 902 of the finger-plate 900 may consist of a flat finger-plate 900 around the thumb tone hole 302 wherein the distal portion transitions to an angled surface that extends to a lowered surface, creating the thumb-plate contouring 902. The thumb-plate contouring 902 can have a greater or lesser angle or height depending on the thumb or configuration. Additionally, the lowered surface may extend up the side of a finger-plate 900 depending on the accommodation to the left or right hand to better accommodate the natural angle and orientation of the thumb.

### Windway Structures

The windway structures 401 of musical instrument 10 are objects or dividers within the windway 102 that form, alter or guide the airstream. These structures may alter the flow of the airstream to become more laminar or more turbulent in instrument 10. Different windway structure 401 designs may improve range, playability, stability, tunability, dynamic range, projection, harmonic stability, responsiveness and tonal characteristics. These structures can either be static or removable.

### Duct Channeling

Duct channeling 402 of musical instrument 10 are depressions, channels, or nicks formed into the duct 105, altering the shape and the flow of the air jet 107. This results in helping direct the air jet 107 below the labium edge 214 and to activate the air column oscillation more quickly.

### Greater Labium Edge

A greater labium edge is a labium edge 214 wherein the measurement of the labium edge 214 is one of equal or greater than 75% of a diameter of a bore 111 excluding flares or tapers. The geometries of the duct 105 determine the volume of the airstream needed to produce sound on the instrument. The benefits of the greater labium edge 214 are optimized when a lesser duct 105 depth is used. In addition, the corresponding greater duct 105 width and lesser duct 105 depth results in a greater percentage of the air jet 107 being cut by the labium edge 214 and utilized in sound production (air column oscillation). As a result, the greater labium edge 214 increases the decibel level of the instrument. Additionally, the lesser depth air jet 107 has greater flexibility, reducing the length of the window 108 and resulting in a faster initiation of oscillation. The lesser length of the window 108 increases the number of playable harmonics which expands the overall range of musical instrument 10. Additionally, the greater width duct can allow for setups wherein the height of a table 205 is greater than the height of a labium edge 214 to achieve a proper ratio. Benefits of the greater labium edge 214 may include: playability, stability, dynamic range, projection, harmonic stability, responsiveness and tonal characteristics

### Micro-shaping the Labium Edge

The micro-shaped labium edge 404 is the configuration of the surface created between the labium face 215 and the labium underface 216. Examples of a micro-shaped labium edge 404 consist of a beveling or fillet to the intersection. Micro-shaped labium edge 404 may alter tone color, clarity of sound, overall decibel level, playability, stability, dynamic range, projection, harmonic stability and response of musical instrument 10.

### Airfoil Cavity

The airfoil cavity 405 may be any space or cavity following the labium edge 214 on the labium underface 216 or bore 111 internal surface, including any angle change to the labium underface 216 or area following the labium edge 214. Adding an airfoil cavity 405 may create a negative air pressure cavity allowing a faster initiation and stabilization of air column oscillation. The airfoil cavity 405 may alter the playability, stability, decibel level, dynamic range, projection, harmonic stability, response and tonal characteristics of musical instrument 10.

### Head Component System

The head component system 500 of musical instrument 10 is a head 100 that hosts a singular or multiple interchangeable, attachable and/or removable head components. The head component system 500 allows for a singular head component or a grouping of multiple head components to be interchangeable. The ability to interchange parts with different geometries allows for multiple unique sounds, timbres, playability, and capabilities to be created from the same instrument. It may allow for easy cleaning and replacement of broken or damaged parts. These interchangeable head components may comprise of: the mouthpiece cap 608, a slow air chamber insert 609, the windway socket 601, the labium socket 602, a windway insert 603, a labium insert 604, a combo insert 607, a beard 610, and an upstream cavity 212. This level of the performance and feel variation may be extremely valuable to novices and professionals to fine tune the instrument to their preference.

A mouthpiece cap 608 for musical instrument 10 is the device that may be attached to the proximal end of the head 100 to make different mouthpiece interfaces. Due to different oral anatomies of humans, every instrumentalist has a preference for the geometries of the mouthpiece interface. With the use of a mouthpiece cap 608, the geometries can be altered, configured or customized to offer a variety of mouthpiece-to-mouth interface options to best suit the player's preference. Additionally, the mouthpiece cap 608 may be used as a way to change the geometries of the slow air chamber 103 and/or can add windway structures 401 to the slow air chamber 103.

The slow air chamber insert 609 may be inserted into the slow air chamber 103 and may allow one to change the geometries of the slow air chamber 103 and/or may add windway structures 401 to the slow air chamber 103 The windway insert 603 may comprise: the slow air chamber 103, slow air chamber-ramp transition 202, ramp 203, ramp-table transition 204, and duct 105.

The labium insert 604 may initially host all of the components of the labium and a portion of the resonator 110. These components may include: labium edge 214, labium walls 213, labium face 215, labium underface 216, and underface-resonator transition 217.

Examples of an alternate windway insert 603 and labium insert 604 are represented by the alternate windway insert 605 and the alternate labium insert 606.

A combo insert 607 may be both the windway insert 603 and labium insert 604 components configured into one insert.

Placing a slow air chamber windway insert 609 into the slow air chamber 103 may be used as a way to alter the geometries of the slow air chamber and/or can add windway structures 401 to the slow air chamber 103 of musical instrument 10.

The ramp 203 is the transition area between the slow air chamber 103 and the duct 105. The most isolated head component to alter for response on a duct head may be the ramp 203 may alter for response on a duct without greatly affecting the other characteristics of the instrument 10. The compression chamber 104 geometries may be configured, as well as the geometries. For example, the angle of the ramp 203, to determine the compression rate of the airstream from the slow air chamber 103 (slow-moving, high-volume airstream) into the duct 105 (fast-moving, low-volume airstream).

The slow air chamber-ramp transition 202 and the ramp-table transition 204 can both be configured to fine tune the response of musical instrument 10. For example, a sharp transition may have a faster response than a curved or rounded transition.

Variations to the duct 105 geometries may alter the characteristics of resistance, response, range capabilities, decibel level, sound, clarity, feel and airstream volume, to name a few. For example, a flat duct 105 with a corresponding flat labium edge 214 may have a more isolated and clear tone compared to an arched duct 105 with a corresponding arched labium edge 214 may have a more complex tone.

Many configurations can be made to a duct 105 at the windway exit 106 to direct the air jet 107. A common design used by recorder makers may be to configure a table bevel 208 and ceiling bevel 209. This may help to spread the air jet 107, resulting in a greater air jet 107 depth, coming out of the windway exit 106 before it strikes the labium edge 214. This technique may be used to affect the sound and response of musical instrument 10 and will also compensate for any changes in geometries resulting from material and from environmental factors and/or while playing.

The window 108 is the opening initiating at the windway exit 106 and terminating at the initiation of the labium 109 between the labium walls 213. The window 108 geometries are a subsidiary effect of how close the labium edge 214 is to the windway exit 106. The closer the labium edge 214 is to the windway exit 106, the more stable harmonics may become. If the labium edge 214 is too close to the windway exit 106, the fundamental register may cease to sound. On the opposite spectrum, if the labium edge 214 is further away from the windway exit 106, there will be dramatic loss of overall range, more wind noise will be present in the sound, and articulations will be more pronounced. If the labium edge 214 moves too far away or is too close in relation to the windway exit 106, the sound production will completely cease.

An upstream cavity 212 on a duct head is a cavity added into the bottom wall 211, underneath the table 205, that may extend from the bottom wall 211 towards the proximal end of the head 100. The upstream cavity 212 may alter the flow of entrained air into the air jet 107. Additionally, it extends the resonator 110 length proximal to the window 108 altering the air column oscillation. In addition, the upstream cavity 212 can be used to alter the tuning of the instrument's overtones.

The geometries of the labium 109 can be configured in a variety of ways. For example, labium 109 with a longer labium face 215 may result in greater projection and clarity as compared to a shorter labium face 215.

The beard 610 is part of or an attachment to the head's 100 top wall 210 of musical instrument 10, that extends the top wall 210 and allows for alterations to the angle. The beard 610 may alter the flow of entrained air (air that is swept into an airstream) into the air jet 107. A beard 610 can have many different geometries which may consist of extending the top wall 210 and allowing for configurations to the angle. Adding a beard 610 to an instrument may alter help with projection as well as change harmonics, dynamics, overall decibel level, tonal qualities, and response of musical instrument 19. The beard 610 can be integral to the head 100 or may be a removable device.

The head component system 500 may provide scaled and optimized versions for other duct heads. If a pre-existing instrument has a head 100 which is not removable, a retrofitted version can be created to host singular or multiple head components in the instrument. Part or all of the original head component would be removed in the one-piece instrument and a new device would be inserted that would host singular or multiple head components.

### Elongated Slow Air Chamber

The elongated slow air chamber 103 of musical instrument 10 comprising an elongated width may allow for a less turbulent flow of the airstream through the slow air chamber 103 and greater variability in configuration when compared with traditional cylindrical slow air chamber 103 designs. The elongated width allows a slow air chamber 103 of greater length and equivalent volume, as compared to a traditional cylindrical slow air chamber design. The greater length reduces the turbulence before the airstream reaches the compression chamber 104. The lesser depth reduces the amount of compression into the duct 105, decreasing the turbulence in the windway 102. The elongated slow air chamber 103 may better accommodate a greater duct 105 width. Additionally, the elongated shape lends itself to an elongated width mouthpiece 201 shape that may improve ergonomics as the shape better replicates the player's mouth shape.

### In-line Windway

A duct head with an in-line windway 102 may greatly improve the airstream turbulence through the windway 102 of musical instrument 10. An in-line windway 102 comprises at least one of a portion of a table 205 or a labium edge 214 having a height equivalent or lesser a height of the internal surface of the resonator 110. An inline windway may comprise a table 205 positioned in-line or within the internal surface of the slow air chamber 103. The in-line design may result in a more laminar flow of the airstream through the windway 102 and air jet 107.

### Bend

A duct head with a compression duct containing one or more bends 700 positioned between the proximal and distal end of the instrument may provide many benefits in ergonomics, tuning, feel, response, and tonal characteristics. First, ergonomics are greatly improved as the addition of a bend 700 may place the instrument in a more natural location for the player's wrist and fingers. For example, a bend 700 placed in the windway 102 may have the benefit of improving ergonomics without impacting the functionality of the resonator 110. Alternatively, the addition of a bend 700 in the resonator 110 can be used to change the tuning in the fundamental register and harmonics, as well as tuning of the tone holes 302 and upper registers. Additionally, the geometries and quantity of the bends 700 are used to configure tonal characteristics and feel. For example, a higher degree bend may result in a darker tonal characteristic as well as may allow for easier register changes for the player. Finally, bends 700 may increase pressure within the resonator 110 thus making a faster oscillation possible, and in turn, extending the playable range on an instrument. This may be beneficial on instruments where the pressure in the resonator 110 is very low.

### Multi-section Resonator

A multi-section resonator 110, having two or more sections, can provide many benefits for musical instrument 10. First, parts can be swapped out for parts with different geometries resulting in different performance capabilities. Second, parts of the instrument can be swapped out to change the fundamental pitch of the instrument, resulting in the instrument being in a different key. For example, swapping the original body 301 with a shorter body 301 tuned to a different key. Third, broken parts may be easily replaced with an exact replacement. Finally, having multiple connection points may allow for fine tuning of each section of the instrument.

The socket 705 and tenon 706 is an attachment device used to attach sections together in a multi-section resonator 110. The socket 705 is what houses the tenon 706 section of the resonator 110 section. The socket 705 is an extension along the established central axis of the section of the instrument 10 and can have external geometries which are congruent with, or greater than, the section it is extending from. The internal cavity of the socket 705 is of geometries to complement the tenon 706. The tenon 706 may be the complementary attachment device to a socket 705 for a multi-section resonator 110. The tenon 706 may be inserted into the socket 705 and have the same bore 111 as the instrument 10. The external geometries of the tenon 706 will typically be the same geometries of the section of the instrument 10 it is attached to, but in some cases may have a reduction in external geometries to accommodate and complete the socket 705. The tenon 706 may have a section of cork or other material inlaid to the tenon 706 to create air tight friction fit between the socket 705 and tenon 706. If the material is inlaid, there may be an indented slot in the tenon 706, extending around the entirety of the tenon 706, creating a ringed reduction in external surface height contained within the length of the tenon 706. This creates an accommodation for a material (for example, cork) that is compressible between the tenon 706 and the socket 705, resulting in a compression/friction fit between the two sections of the instrument.

### Bell

A bell 707 on musical instrument 10 is an expansion of bore 111 diameter initiating along the resonator 110 and terminating at the resonator-termination 303. The bell 707 may be configured as a part of the footjoint 704 or part of the body 301. Adding a bell 707 to a duct head with a compression duct, may help project the sound of the instrument.

### EMBODIMENTS

According to one or more embodiments, the musical instrument 10 may have a headjoint 400 with a head component system 500; a multi-section resonator 110 coupled to a distal end of the headjoint 400. The headjoint 400 may have an elongated width slow air chamber 103 and an elongated width mouthpiece 201 to match the geometries of the slow air chamber 103. An in-line duct 105 and slow air chamber 103. The head component system 500 may be made up of a headjoint shell 600 and the headjoint shell 600 in turn comprises the mouthpiece 201; the slow air chamber 103; a windway socket 601; and a labium socket 602. The head component system 500 may also have: a mouthpiece cap 608 that is removably coupled to the mouthpiece 201; a slow air chamber insert 609 that is removably inserted inside of the slow air chamber 103; a windway insert 603 removably inserted into the windway socket 601; and a labium insert 604 removably inserted into the labium socket 602. The exterior surface of the windway insert 603 and the exterior surface of the labium insert 604 may have ridges formed thereon, which will help a user when removing the windway insert 603 or the labium insert 604. The exterior surface of the windway insert 603 and the exterior surface of the labium insert 604, when installed, may be flush with the exterior surface of the headjoint 400. The windway insert 603 may have: a portion of the slow air chamber 103; a slow air chamber-ramp 202; a ramp 203; a ramp-table transition 204; a duct 105; a top wall 210; and a bottom wall 211. Ideally, the ramp 203 may have a steep angle, the ramp-table transition 204 will be rounded, and the duct 105 will be arched. The labium insert 604 may have: an arched labium edge 214; a labium face 215; a labium underface 216; an airfoil cavity 405 formed within the labium underface 216; and a labium underface-resonator transition 217. The labium insert 604 may also form the window 108, which may have a width measurement greater than a length measurement. Preferably, the labium walls 213 may be lessened in height to be equal to or below a height of a ceiling 206 of the duct 105.

The multi-section resonator 110 may have; an angled neck 701; an upper body 702; a lower body 703; and a footjoint 704. The multi-section resonator 110 may also have a plurality of elongated tone holes 801 and squircle tone holes 802 along its length. A plurality of width contouring 901 of finger-plates 900 and thumb-plate contouring 902, surrounding the elongated tone holes 801 and squircle tone holes 802 may be used. Furthermore, the elongated tone holes 801 and squircle tone holes 802 may have chamfered edges. The positioning of the tone holes 302 on the multi-section resonator 110 may consist of: four elongated tone holes 801 formed on a top surface of the upper body 702 and four elongated tone holes 801 formed on a top surface of the lower body 703; a plurality of width contouring 901 of finger-plates 900, surrounding one of the plurality of elongated tone holes 801; a squircle tone hole 802 formed on a bottom surface of the upper body 702; and a squircle tone hole 802 formed on a bottom surface of the lower body 703; a finger-plate 900 and thumb-plate contouring 902 surrounding the plurality of squircle tone holes 802.

The present invention discloses solutions to the above-mentioned shortcoming of currently used wind instrument solutions, particularly: elongated tone holes 801; squircle tone holes 802; width contouring 901 of finger-plates 900; thumb-plate contouring 902; windway structures 401; duct channeling 402; a beard 610; a labium edge 214 measure that is equal or greater than 75% of the diameter of the bore 111; a labium underface 216 containing an airfoil cavity 405; a head component system 500; an elongated slow air chamber 103; bends 700; an in-line windway 102; a multi-section resonator 110; and a bell 707.

It is to be noted, above-mentioned improvements may be used on other types of wind instruments, duct heads, and/or compression ducts other than instrument 10.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed:

1. A musical instrument comprising:
a head; and
a resonator; wherein the resonator is positioned distal the head and at least one of the head and the resonator allows one to change at least one of a range, a response, a feel, ergonomics, and tonal characteristics.

2. The musical instrument of claim 1, wherein the resonator comprises a pitch control mechanism comprising at least one of a plurality of tone holes and a plurality of finger-plates wherein geometries of at least one of the plurality of tone holes and the plurality of finger-plates are configurable.

3. The musical instrument of claim 1, wherein the head comprises a duct in the windway.

4. The musical instrument of claim 2, wherein the plurality of tone holes are elongated so a width measurement is greater than a length measurement.

5. The musical instrument of claim 2, wherein the finger-plate comprises width contouring wherein a surface of the finger-plate extends upward as a width extends from the center.

6. The musical instrument of claim 2, wherein the finger-plate comprises a lowered surface distal a thumb tone hole.

7. The musical instrument of claim 3, wherein a labium edge measurement is one of equal or greater than 75% of a diameter of a bore excluding flares or tapers.

8. The musical instrument of claim 3, wherein a labium underface surface comprises an airfoil cavity.

9. The musical instrument of claim 3, wherein the head comprises a head component that is at least one of interchangeable, attachable and insertable.

10. The musical instrument of claim 3, wherein the head comprises a compression duct.

11. The musical instrument of claim 10, wherein the instrument contains one or more bends to a central axis positioned between a proximal end and a distal end of the instrument.

12. The musical instrument of claim 10, wherein a height of a table is greater than a height of a labium edge.

13. The musical instrument of claim 10, wherein a height of a table has a height equivalent or lesser a height of the internal surface of the slow air chamber.

14. The musical instrument of claim 10, wherein at least one of a portion of a table or a labium edge comprise a height equivalent or lesser a height of the internal surface of the resonator.

15. The musical instrument of claim 10, wherein the resonator is a multi-section resonator comprising at least two sections.

16. The musical instrument of claim 10, wherein a portion of the resonator comprises a bell.

17. The musical instrument of claim 2, wherein the tone hole is a squircle.

18. The musical instrument of claim 3, wherein the windway comprises windway structures that alter a flow of an airstream in the windway.

19. The musical instrument of claim 3, wherein the windway comprises a duct channeling altering a flow of an air jet.

20. The musical instrument of claim 3, wherein the geometries of the top wall contain two or more surfaces.

21. The musical instrument of claim 3, wherein the head comprises a beard.

22. The musical instrument of claim 3, wherein the labium edge is micro-shaped.
